(19) United States
(12) Patent Application Publication
(10) Pub. No.: US 2020/0283004 A1
(43) Pub. Date: Sep. 10, 2020

(54) METHOD AND SYSTEM FOR OVERRIDING VEHICLE SYSTEMS BASED ON SPECIAL CONDITIONS

(71) Applicant: International Business Machines Corporation, Armonk, NY (US)

(72) Inventors: Albert AVETISIAN, Bayside, NY (US); Michael BENDER, Rye Brook, NY (US); Gregory J. BOSS, Saginaw, MI (US); Jeremy R. FOX, Georgetown, TX (US)

(21) Appl. No.: 16/294,444

(22) Filed: Mar. 6, 2019

(51) Int. Cl. B60W 50/00; G05B 15/02; B60R 16/023; H04L 29/08; H04L 12/24; H04W 4/40

(52) U.S. Cl. CPC B60W 50/0098; G05B 15/02; B60R 16/0231; H04L 67/12; H04L 41/0816; H04W 84/042; B60W 2050/0083; B60W 2550/12; B60W 2050/0077; B60W 2720/10; B60W 2710/10; H04W 4/40

(57) ABSTRACT

A method (and structure and computer product) for overriding a configuration setting on a vehicle includes receiving input data from one or more sensors on the vehicle. By using the sensor input data it is determining that a predetermined special condition currently exists for which it is predetermined that a change in a configuration setting is desired. A signal is provided to change the configuration setting from an original setting value to a new configuration setting value.

### BACKGROUND

The present invention relates generally to control of configuration settings on vehicles. More specifically, based on analyzing data from embedded sensors on the vehicle or from remote sensors, vehicle settings can be automatically selectively overridden when the analysis indicates that a special condition warrants a temporary change of a setting, and then selectively returned to the original settings when the condition is determined as no longer being present.

### SUMMARY

In a first exemplary aspect of the present invention, described herein is a method for overriding a configuration setting on a vehicle, including: receiving input data from one or more sensors on the vehicle; determining, using the sensor input data, that a predetermined special condition currently exists for which it is predetermined that a change in a configuration setting is desired; and providing a signal to change the configuration setting from an original setting value to a new configuration setting value.

In a second exemplary aspect of the present invention, described herein is a vehicle configuration override system circuit, including: an input port to receive input data from one or more sensors on the vehicle; a computation circuit for determining, using the sensor input data, that a predetermined special condition currently exists for which it is predetermined that a change in a configuration setting is desired; a signal generation circuit for providing a signal to change the configuration setting from an original setting value to a new configuration setting value; and an output port to provide the signal to change the configuration setting.

In yet another exemplary aspect, herein is described a vehicle configuration setting override computer, including: an input/output port for receiving input data from a vehicle communication bus and to provide a signal onto the vehicle communication bus; a transceiver capable of accessing a network; a processor; and a memory device accessible to the processor for storing a set of instructions enabling the processor to implement a vehicle configuration setting override method. The vehicle configuration setting override method includes: receiving input data from one or more sensors on the vehicle via the vehicle communication bus; determining, using the sensor input data, that a predetermined special condition currently exists for which it is predetermined that a change in a configuration setting is desired because of potential damage to the vehicle if a configuration setting were not changed; providing a signal to the vehicle communication bus to change the configuration setting from an original setting value to a new configuration setting value; continuing to receive input data from the one or more sensors via the vehicle communication bus to monitor whether the predetermined special condition continues to exist; determining that the predetermined condition no longer exists; and providing a signal to the vehicle communication bus to change the configuration setting value back to the original setting value, wherein the determining that the predetermined special condition exists is based at least partially on information received from the network via the transceiver.

### BRIEF DESCRIPTION OF THE DRAWINGS

FIG. 1 shows an exemplary embodiment of the present invention using a centralized architecture;

FIG. 2 shows in flowchart format 200 steps of exemplary embodiments of the invention;

FIG. 3 shows exemplarily a decentralized embodiment of the invention;

FIG. 4 shows exemplary hybrid embodiments of the invention;

FIG. 5 depicts a cloud computing environment according to an embodiment of the present invention; and

FIG. 6 depicts abstraction model layers according to an embodiment of the present invention.

### DETAILED DESCRIPTION

Current vehicles are vastly configurable by drivers to make configuration settings to their preferences for various systems on the vehicle. However, such capability places an inherent responsibility on the drivers themselves since they must have the ready knowledge and understanding of which settings are best for each weather condition and terrain. Certain special conditions in an environment of a vehicle could make it desirable to change one or more vehicle configuration settings, including non-limiting examples such as drive train settings or brake settings. The present inventors have recognized that it would be desirable to incorporate a system that would remove the element of user error as well as relieve the responsibility of the driver when it comes to selecting and possibly continuously adjusting vehicle configuration settings.

An exemplary scenario is demonstrated by a vehicle to be towed. If the vehicle is turned off, there is currently no way to ensure that the vehicle settings are adjusted or set to prevent damage to the drive train or brake system components. Even if the driver or owner of the vehicle is present as it is about to be towed, he or she may have no idea of appropriate settings to make for various systems such as brakes or transmission. Various embodiments of the present invention provide an analysis platform to determine when a special condition exists that would make it appropriate to temporarily override configuration settings for purpose, for example, of preventing damage to components or for other safety concerns for the vehicle and to automatically make changes to current configuration settings during such special condition.

By using sensors in the vehicle itself or, in some exemplary scenarios, information as input obtained via an IoT (Internet of Things) communication device, embodiments described herein determine when current configuration settings should be changed and, in some systems, automatically make changes until the special conditions are no longer detected. In other exemplary scenarios the system could provide a warning and permit the driver to make a recommended change.

Modern vehicles are being built with sophisticated sensors and cameras pre-installed, often for specific purposes in specific subsystems such as engine control or navigation, including computation capability for image analysis and other cognitive engines to interpret various audio and/or video feeds, as well as processing sensor input data. Additionally, modern vehicles are increasingly incorporating one or more communication busses to permit intercommunications between different modules on the vehicle, typically referred to as nodes. These modules can also be called computers or controllers, and can have various levels of computerization, including incorporation of a Central Processing Unit (CPU) and an associated re-programmable memory.

As an example of a vehicular communication bus, in the United States, the Society of Automotive Engineers (SAE) standards now include class A low-speed networks for less than 10,000 bits per second (10 Kbps), class B medium-speed networks for 10 Kbps-125 Kbps, and class C high-speed networks for 125 Kbps to 1,000 Kbps. The class A networks are used for such low-speed applications as trip computers and entertainment and other convenience features. The medium class B networks are generally used for information transfer among modules, such as instrument clusters, temperature sensor data, and other general uses. The class C networks are used for real-time powertrain and vehicle dynamic control.

Another important vehicular communication protocol is the Control Area Network (CAN) bus, initially developed in 1993 and approved by the Environmental Protection Agency (EPA) for diagnostics on vehicles beginning in 2003. CAN is a legal requirement for all vehicles beginning in 2008. This CAN bus provides parameter data available via the standard diagnostic On-Board Diagnostics Second Generation (OBD-II) data link connector mounted typically under the left side of a vehicle, used for connection to diagnostic scan tools, some of which scan tools include capability of interacting with various systems for injecting test signals in order to exercise/test various components on the vehicle. The CAN protocol incorporates three classes of signals CAN A, CAN B, and CAN C having different configurations and speeds, and these different classes of signals can intercommunicate using a gateway.

Since the modern automobile may have 70 or more Electronic Control Units (ECUs) for various subsystems, the CAN bus can be connected to a relatively large number of vehicle subsystems via a node computer or controller used in those subsystems. For example, CAN conventionally has been used to connect to the engine control unit, the transmission, airbags, antilock braking system (ABS), cruise control, electric power steering, audio systems, power windows, doors, mirror adjustment, battery and recharging systems on hybrid/electric cars. An advantage of using a vehicular bus such as CAN is that various safety, economy, and convenience features can be implemented using software rather than adding cost and complexity if implemented using hard wiring or additional components.

Examples of CAN-based additional features that have been implemented to date include:
An auto start/stop feature in which various sensor inputs such as speed sensors, steering angle, air conditioning ON/OFF, and engine temperature are considered via the CAN bus to determine whether the engine can be shut down when the vehicle is stationary, for improved fuel economy and emissions.
An electric park brake system feature in which a vehicle's tilt sensor, as also used in vehicular burglar alarm subsystems, and road speed sensors, as also used by the ABS, engine control, and traction control subsystems, provide a “hill hold” functionality to determine if the vehicle is stopped on an incline during which an automatic application of the parking brake might be appropriate. Similarly, seat belt sensors, as already used in an airbag control subsystem, could provide a signal via CAN to automatically release the parking brake when the vehicle is started up and moves with the parking brake inadvertently still set.
A parking assist feature in which, when reverse gear is engaged, the transmission control unit can send a signal via CAN to activate both the parking sensor system and the door control module for the passenger side door mirror to tilt downward to show the position of the curb during a parking event. This parking assist feature can also receive an input via CAN from a rain sensor so as to automatically trigger the rear windscreen wiper when reversing.
A lane assist/collision avoidance feature in which outside proximity data from parking sensors are provided to actuate braking by wire in a collision avoidance system.
An auto brake wiping feature in which an imperceptible application of brakes while driving can be applied to clear moisture from brake rotors, as based on input via CAN from a rain sensor, as used for automatic windscreen wipers on some high-performance Audi and BMW models.

Other countries, vehicle manufacturers, and vehicular subsystem manufacturers have developed and implemented various vehicle bus systems to interconnect vehicular subsystems and/or components within a subsystem. In one example, five European automakers and various subsystem suppliers founded a consortium for developing and implementing the Local Interface Network (LIN) bus standard in the late 1990s, as a low-cost method to complement CAN for non-critical subsystems such as air-conditioning and infotainment, where reliability and transmission speed are not critical. The LIN system is a broadcast serial network having sixteen nodes, including one master node and up to fifteen slave nodes. All messages are initiated by the master node, with at most one slave replying to a given message identifier, and the master node can also act as a slave node by replying to its own messages. Typically, microcontrollers are used for LIN nodes, but the nodes could also be implemented in specialized hardware or Application Specific Integrated Circuits (ASICs) to save cost, space, or power. Current uses of the LIN bus combine the low-cost efficiency of LIN and simple sensors to create small vehicle networks that can be connected by a backbone network such as CAN, thereby permitting hierarchical networks within vehicles.

The present invention is not limited to any specific vehicular bus and, instead, is intended to utilize any appropriate conventional vehicle bus system and, preferably, one or more existing sensor or actuator that is already incorporated in a vehicular subsystem. Another feature of some embodiments of the present invention is that of enhancing vehicular subsystem capabilities by further using concepts evolving under IoT (Internet of Things), in which networks such as vehicles, home appliances, and other systems and subsystems extend Internet connectivity beyond standard devices such as desktop computers, laptops, smart phones, and tablets, to any range of traditionally dumb or non-internet-enabled physical devices and everyday objects to allow these things to connect, interact, and exchange data. Using various embedded technologies, IoT permit devices to communicate and interact over the Internet to provide remote monitoring and control.

In the context of some embodiments of the present invention, the concept of IoT is intended as referring to a cellular-based or satellite-based interface incorporated on the vehicle that permits Internet access that can provide information or data relevant to detecting special conditions for the vehicle or for special conditions related to specific systems or subsystems of the vehicle, along with the capability to cause an action within a vehicle system or subsystem, including examples described herein. As will become clear with various non-limiting examples described shortly, the detection of the special condition may require inputs from sensors on the vehicle. But in other examples, the special condition for initiating a configuration setting change is defined by communication to a vehicle system or subsystem via an IoT interface such as a cellular or satellite interface, using an Internet or cloud service that can uniquely identify and communicate with a specific vehicle to request a configuration setting change based on this request alone. It is also noted that some embodiments of the present invention do not necessarily receive information from the Internet but can perform their desired functions using only local sensor inputs from the vehicle itself, although there could be an onboard computer that is involved with or that implements the determination of the special condition invoking a pre-determined configuration setting change, typically involving a cognitive engine for data analysis, such as image data from a camera, to determine whether a predetermined special condition currently exists that would invoke a configuration setting override.

In some embodiments IoT concepts are used in vehicles having one or more vehicular buses such as CAN or LIN described above, including exemplary implements that involve cloud services, to override configuration settings on that vehicle. However, embodiments of the present invention should not be considered as strictly limited to such vehicle configurations having one or more communication buses since concepts of the present invention are equally applicable to vehicle systems or subsystems without using a vehicle communication bus, meaning that embodiments of the present invention can also be applied in systems designed to receive sensor inputs and generate a signal to control an actuator to achieve a configuration setting change or provide a warning to alert a user of a desired configuration setting change without utilizing a vehicle communication bus. Moreover, the concept of exemplary embodiments utilizes one or more IoT-based devices or interfaces into older vehicles not having such communication buses could be achieved within a vehicle system or subsystem by modification that add an IoT interface or control module.

Exemplary embodiments of the present invention typically use existing embedded sensors on vehicles, such as, for example, gyroscopes, accelerometers, proximity sensors, and Global Positioning System (GPS) data. In some embodiments, the system will use these sensors to detect certain conditions happening on and/or around the vehicle to automatically change a state of car components based on interpretation of IoT feeds that are used to detect other states of interest for the vehicle.

The connection of vehicles such as automobiles to the Internet and to mobile telecommunications systems is well known in the art, as demonstrated by the advent of the OnStar system in 1996 by General Motors (GM) working with Motorola Automotive. OnStar permitted drivers or passengers to contact a call center via a cellular system to request an agent contact authorities to respond to an emergency. When cellular systems added data capability, the OnStar system was able to send GPS location automatically so that a caller did not need to describe their present location.

Other examples of vehicle connectivity to the Internet is evidenced by the connected car services beginning in 2001, for remote diagnostics, by the health reports, turn-by-directions, and network access devices beginning in 2003, by data-only telematics were first offered in 2007, and by Audi being the first automaker to offer in 2014 access to 4G LTE WiFi hotspots and GM making the first mass deployment of 4G LTE. Recently, Vehicle to Cloud (V2C) technology permits information exchange between a cloud service and applications on a vehicle.

Embodiments of the present invention takes advantage of these relatively recent improvements in vehicle system design to incorporate buses that permit selective intercommunication between different vehicle modules, subsystems, and systems, and between vehicles and the Internet to further permit IoT technology to be incorporated into vehicles to provide a configuration override capability.

Several non-limiting examples of configuration override scenarios will now be described. A common goal in these first three examples is to prevent inadvertent damage to the vehicle.

In one specific exemplary embodiment, a configuration override system provides a towing configuration override capability. Specifically, in this embodiment, it is assumed, for example, that a vehicle is turned off and locked, as detected by various sensors, and the vehicle operator is not present to make any manual adjustments when a tow truck operator begins a normal towing process. The configuration override feature of the present invention would detect changes in vehicle positioning and would make override decisions to change configuration settings on subsystems such as brakes and transmission, so as to prevent possible damage to these subsystems during towing. Additional sensor inputs appropriate for detecting the special condition of towing might include, for example:
The vehicle is detected as being within a predetermined range of angles appropriate for towing;
An image from a front-facing camera is analyzed as identifying an image of a tow truck;
A light sensor or camera image data suggests a tow truck beacon;
Analysis of an image from a camera taking an inside image indicates that no driver is present but the vehicle is moving. Absence of a driver might also be detected by other sensors such as a weight sensor or seat belt sensor. The analysis of camera image data could be provided via a cloud service using an IoT interface to the vehicle, or could be achieved by a computer onboard the vehicle.

Some of these sensor inputs described above would require analysis using some form of a cognitive engine to interpret the input data as satisfying the special condition of towing.

Having determined that the vehicle is likely being or about to be towed, the configuration override system could change the configurations set by the driver by, for example, moving the transmission into neutral gear, disabling the parking brake, and turning on the emergency hazard flashers, etc. The configuration override system would be able to restore the previous configuration settings once it detects that input sensors provide data indicating that the special condition such as towing is no longer present.

In another specific exemplary embodiment, the configuration override system provides vehicle protection during a carwash. In this implementation, the configuration override system detects that the vehicle is likely involved in a carwash process. Sensors that would permit the configuration override system to detect a pending carwash condition might include, for example:
Input GPS data indicates that the vehicle has approached a carwash, and Internet data, as obtained via an IoT interface, indicates that the car wash is currently open;
A sudden change in light to darkness, as detected by light sensors;
A sudden spray of water unrelated to weather, as detected by water or rain sensors;
and confined space;
Analysis of image data from an inside-looking camera indicates that the driver is not holding the steering wheel; and
Speed sensors indicate movement at a slow speed.

These detected conditions would cause the configuration override system to trigger a sequence of configuration adjustments including, for example, changes to transmission configuration such as placing the vehicle in park or neutral, disabling the steering, disabling the brakes, folding side-mirror setting, shutting down of air conditioning, and closing of windows. The configuration override system could restore the previous configuration settings once it detects that the special conditions of towing are no longer active. This example also uses input data that would involve one or more cognitive engines in order to interpret the input data relative to the purpose of protecting the vehicle during a carwash.

In yet another specific exemplary embodiment, the configuration override system could override other configuration settings for speed and/or gear settings to lower speed and/or lower the transmission gear if one or more of the following exemplary conditions were detected:
A sensor detects a heavy increase in water;
A sensor provides data interpreted as the driver adjusting to windy conditions;
A weather forecast for the current position of the vehicle, as obtained via an IoT interface, predicts rain and/or high winds; and
The anti-lock brake subsystem is engaging above a predetermined amount of frequency.

The configuration override system would be able to restore the previous configuration settings once it detects that the special conditions of towing are no longer active.

A cognitive engine is needed to implement the analysis required to detect the special condition involved in these three examples. Such analysis could be executed by a computer in the vehicle itself or could be executed remotely as, for example, in a cloud service contacted via an IoT interface transceiver in the vehicle.

Other nonlimiting examples of specific features possible with embodiments of the present invention as an incorporation of an IoT transceiver into a vehicle might include:
unlocking doors or starting up a vehicle when keys or other entry device is inadvertently locked inside the vehicle or when a key fob fails to function for starting up the vehicle, by contacting a remote lock unlock/startup application via a smartphone and an Internet connection to the vehicle, such as a cloud service specifically set up for this application, including a password being registered by users to prevent third parties from using the service;
initiating a sequence remotely via the Internet to obtain and report current GPS location of the vehicle, similar in concept to that of the conventional technique of operating a horn in response to remotely pressing the “panic” button on a key fob. Based on request via an IoT interface from, for example, a law enforcement agency, the configuration setting override system of the present invention would receive a request to initiate a sequence obtains and reports current location to, for example, a cloud service or other Internet mechanism;
lowering (or raising) cruise control setting (or at least provide a warning to driver) based on current location of vehicle relative to a speed limit for that location, as determined by map data available through an Internet connection.

From the non-limiting list of examples above, it should be clear that embodiments of the present invention provide new opportunities to incorporate automatic features into vehicles that affect or override possible configuration settings on vehicles.

### System Implementation

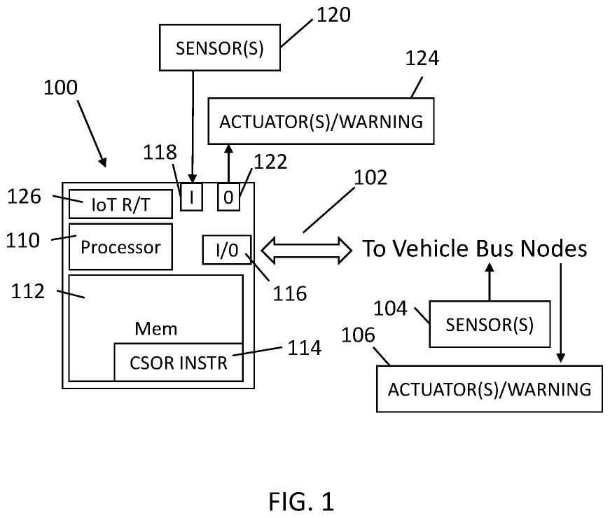

Depending upon what special condition is being addressed, embodiments of the present invention can be implemented by taking any of various different approaches, including implementations involving one or more cloud services. FIG. 1 shows one exemplary embodiment taking a centralized approach in which a Configuration Override Module (COM) 100 provides at least some configuration override functions that are implemented/available on a specific vehicle (e.g., specific model, year, vin, etc.). In this centralized approach, the COM 100 includes a processor 110 and associated memory device 112 that includes instructions 114 to implement whichever configuration setting override (CSO) features have been enabled for the specific vehicle into which it has been incorporated, including, if appropriate, execution of a cognitive engine that determines whether specific conditions are currently present and generation of signals to actuators or warning devices as appropriate for a detected special condition. In this exemplary embodiment, the COM 100 is connected to a vehicle communication bus 102 to various nodes on the vehicle which provide sensor input data 104 into the COM 100 and provide actuators/warnings 106 to implement configuration setting changes generated by the COM 100. The I/O port 116 serving as a bus interface could be a single I/O port 116. as exemplarily illustrated, or there could be comprised of an input port and an output port. A separate input port(s) 118 could receive sensor 120 data directly and a separate output port(s) 122 could be used for transmitting a signal to an actuator 124 or a controller for an actuator or actuate a warning light or message. The COM 100 could also be considered as a module node on one of the vehicle buses.

The COM 100 in this exemplary embodiment also includes a transceiver 126 to access a network, such as the Internet, using, for example, cellular and/or satellite technology. The processor could execute any cognitive engine functions required to analyze input data for satisfaction of various input conditions required to determine existence of any specific special condition to a configuration setting change function. Alternatively, such cognitive analysis could be transmitted to the Internet for execution, should the processor not have the specific cognitive engine installed.

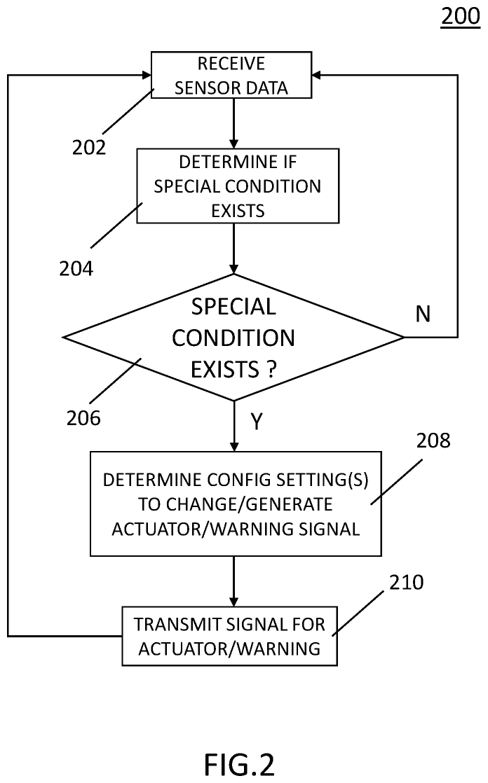

FIG. 2 shows an exemplary method 200 of one or more embodiments of the invention, in which input data is received from one or more sensors in step 202, permitting a determination of whether a special condition exist in step 204. If a special condition is determined to exist in step 206, the system will then determine in step 208 which specific configuration setting(s) should be changed for that specific condition so that a signal can be generated and transmitted in step 210.

This centralized approach demonstrates how some embodiments of the present invention could incorporate many different configuration override functions for many different vehicle models, with precise definitions for detecting special conditions for specific override features. For example, different vehicles might incorporate different sensors so that detection of a specific special condition might require different sensor inputs for the specific model and make of vehicle. The COM 100 could contain instructions for detecting various special conditions with definitions of specific sensor input(s) necessary to achieve a specific configuration override, given an input which identifies into which specific vehicle make/model the COM 100 is currently being incorporated. Alternatively, in another exemplary embodiment, the COM 100 is programmed after installation by downloading appropriate instructions into a generic configuration override computer, with a memory device capability of being reprogrammed for updates as necessary.

As exemplarily demonstrated in FIG. 1, the COM 100 has at least one input/output (I/O) port connected to a communication bus 102 in the vehicle, such as the CAN or LIN bus described above, thereby permitting the COM 100 to receive inputs from various sensors or systems on the vehicle, as well as permitting the COM 100 to provide commands to various actuators throughout the vehicle to achieve a configuration override. Thus, the COM 100 becomes one more module on the vehicle utilizing the communication bus 102 as a node, just like conventional modules servicing various systems throughout the vehicle.

For example, if the COM 100 detects a special condition in which a window is to be raised or a door unlocked, based on receiving data on the communication bus 102 that is reporting various sensors of interest for that special condition, the COM 100 would use the communication bus 102 to transmit a command to a body control module, the specific node on the communication bus that serves to control vehicle body subsystems such as door and window actuators for some vehicles. Other subsystem or system modules connected to the communication bus 100 would be involved in, for example, controlling configuration settings in the transmission. In some embodiments, the COM 100 also includes a transceiver 126 for cellular/satellite Internet access. For example, if no other node on the communication bus 102 permits Internet access to the configuration setting override system, the COM 100 can include and use the transceiver for access to the Internet. In other embodiments, the configuration setting override system might be able to utilize an Internet access available over the communication bus 102.

Utilizing a control unit, such as the COM 100, in a vehicle as a centralized configuration setting override system also permits embodiments of the present invention to be implemented in a vehicle without using a vehicle communication bus, by using wiring directly between sensors 120 and the control unit and between the control unit and appropriate actuators 124, as demonstrated in FIG. 1.

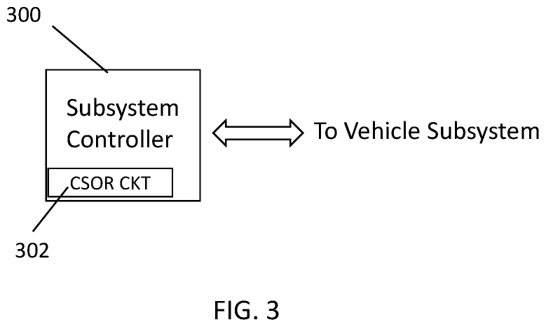

In an alternate exemplary embodiment that represents the opposite extreme to a centralized configuration, some embodiments of the present invention are also incorporated locally by updating a module on the vehicle that contains the control function for appropriate actuators such as window or door actuators, as exemplarily shown in FIG. 3. Thus, if the vehicle already has a control module 300 such as a body module controlling window and door actuators as one node in a vehicle communication bus, the configuration override features related to functions serviced by that module could be incorporated into the module itself, either by adding or modifying an ASIC 302 in the module, or by adding/modifying software in the module, thereby creating a distributed configuration override system. In such exemplary embodiments, such additional circuit 302 in an existing system or subsystem controller or module 300 could be described as a configuration override system circuit, or a configuration override system computation circuit.

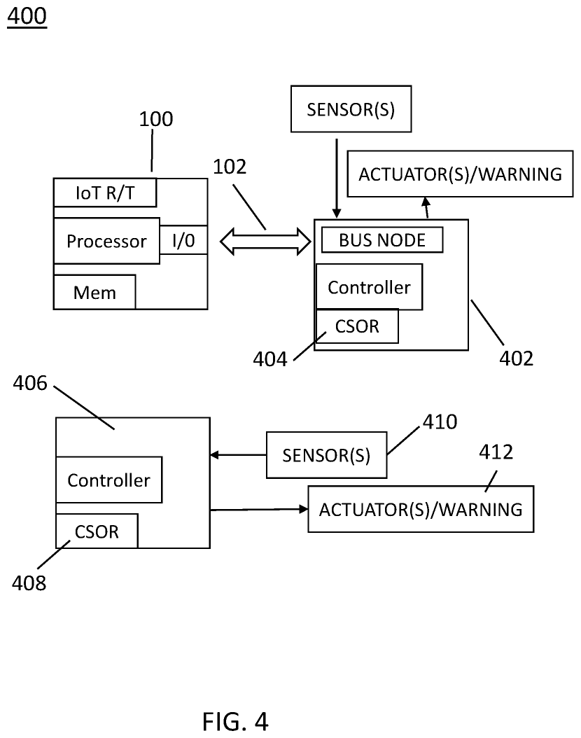

Additionally, a hybrid system 400 exemplarily shown in FIG. 4 is implemented in yet other embodiments of the present invention, in which some configuration override features are incorporated using a COM 100, whereas other configuration override features are incorporated by appropriate modification of existing node module(s) 402 on the vehicle communication bus 104, as exemplarily shown in FIG. 4. In the hybrid configuration 400, the configuration setting override features 404 programmed into separate vehicle systems 402 might still be implemented into a vehicle system control module 402 that interfaces with a vehicle communication bus 102, similar to the exemplary configuration shown in FIG. 1. And, in some hybrid configurations, some configuration setting override features 408 might be implemented in which a vehicle communication bus is not needed if, for example, a vehicle system or subsystem has an existing controller/module 406 that directly receives sensor inputs 410 and directly sends control signals to one or more actuator(s)/warning 412.

It is also noted that, although in various embodiments and configuration setting override scenarios, a computer processor detects whether a special condition exists that warrants a configuration setting override, some embodiments of the present invention could also be implemented in some scenarios without overhead of a processor and memory if the special condition can be detected by simply using a hardware logic circuit to detect sensor inputs and supplying an appropriate signal to a sensor from an appropriate sensor. For example, in the exemplary scenario of unlocking a door upon receipt of a signal from a cloud service, if a door/window control unit is directly wired to appropriate sensors, a logic circuit could be utilized to provide an output to raise/lower a window or lock/unlock a door lock under the special condition. As is well known in the art and depending upon specific aspects possibly unique to a specific configuration override situation, such hardware logic circuit could be implemented in a combinatorial logic circuit, a sequential logic circuit, or a finite state machine. Additionally, the configuration override feature could be implemented by adding or modifying hardware of a control module currently on a vehicle for controlling or monitoring a vehicle system or subsystem, including addition of an application specific integrated circuit (ASIC) to an existing module.

One aspect of some embodiments of the present invention is to implement IoT technology for purpose of overriding configuration settings on vehicles. Thus, some embodiments of the present invention use IoT devices in at least some of its override features, either as an IoT device on the vehicle, such as an Internet interface used to provide map information relative to a configuration override feature or to remotely provide one or more cognitive engine services related to configuration override, or to provide a vehicle interface to a cloud service that provides an override feature to a specific vehicle, such as permitting a user to use a smart phone to remotely unlock a locked door or to start up and operate the vehicle without an ignition key or fob.

Another aspect of some embodiments of the present invention is the detection of special conditions related to configuration settings, sometimes involving complex data that can be interpreted only by using a cognitive engine. For example, the combination of sensor inputs to detect whether the vehicle is about to be towed or to enter a car wash environment would require analysis by a cognitive engine. Another aspect of some embodiments of the present invention is that in most applications, the configuration setting value or values are returned to their original values upon detecting that the special condition no longer exists. Thus, in the towing scenario, the brake and transmission settings can be returned to their original setting once the towing operation is determined as no longer existing.

Finally, relative to involvement with the Internet or a cloud service, it should be clear that access to the Internet and/or a cloud service could be used in several ways in implementing various embodiments of the present invention. For example, the Internet could be used to provide map data or weather or traffic information. A cloud service might be utilized for specific configuration override features such as unlocking a door or permitting the vehicle to be started up and driven, based on a registered user who contacts a cloud service having the function of interacting with a vehicle configuration override system by a user using a smartphone to call up the cloud service to enter a specific password and request. The cloud service would then use a cellular or satellite service to contact the specific vehicle and provide an instruction to remotely unlock a door or remotely start up the vehicle to be driven without a fob or key. Upon release by the cloud, the configuration override system would then return the vehicle to its original condition.

Therefore, in view of the above descriptions, although this disclosure includes a detailed description on cloud computing, as follows, one having ordinary skill would understand that implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

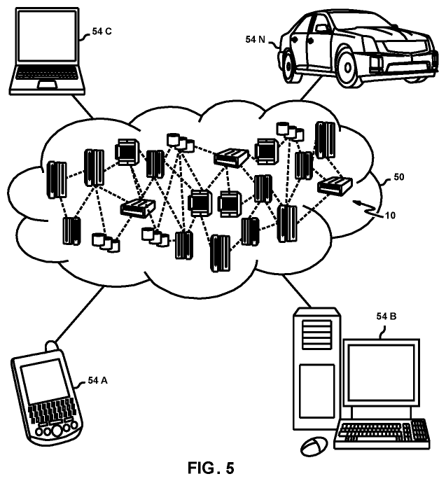

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

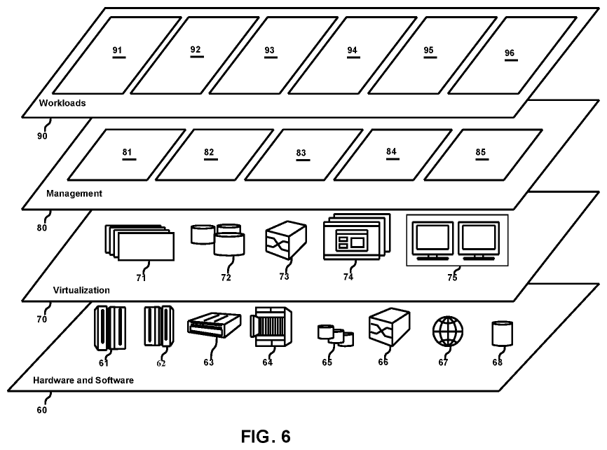

Referring now to FIG. 6, a set of functional abstraction layers provided by cloud computing environment 50 (FIG. 2) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include tasks related to the implementation of the present invention in which FOPE is incorporated, for example, into a DBaaS-based cloud service.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

What is claimed is:

1. A method for overriding a configuration setting on a vehicle, the method comprising:
receiving input data from one or more sensors on the vehicle;
determining, using the sensor input data, that a predetermined special condition currently exists for which it is predetermined that a change in a configuration setting is desired; and
providing a signal to change the configuration setting from an original setting value to a new configuration setting value.

2. The method of claim 1, further comprising returning the configuration setting to the original setting in response to determining that the predetermined special condition no longer exists.

3. The method of claim 1, wherein the vehicle incorporates a vehicle communication bus that permits an intercommunication between different control modules in the vehicle, each control module comprising a node on the vehicle communication bus, and
wherein at least one of the sensor input data and the signal to change the configuration setting utilizes the vehicle communication bus.

4. The method of claim 1, as implemented in a centralized configuration architecture in which a configuration setting change module receives the sensor input data and performs processing to detect that the special condition exists and generates the signal to change to the new configuration setting value.

5. The method of claim 1, as implemented as part of a distributed configuration architecture in which a configuration setting change module is implemented within a control module for a specific system or subsystem of the vehicle to receive the sensor input data, to perform processing to detect that the special condition exists, and to generate the signal to change to the new configuration setting value within the specific system or subsystem.

6. The method of claim 1, as implemented by one of a software change to software in a computer-based module controlling a system or subsystem of the vehicle and a hardware change in a module controlling a system or subsystem of the vehicle.

7. The method of claim 1, as configured to make one or more configuration setting changes due to determining a special condition comprising that: the vehicle is being or about to be towed, the vehicle is inside or about to enter a car wash, that at least one of weather and road conditions require at least one of a change in a setting of speed and a change in a setting of a transmission gear.

8. The method of claim 1, as implemented by a set of computer-readable instructions stored on a non-transitory memory device in a computer-based module having a processor to implement an execution of the determining that the special condition currently exists.

9. The method of claim 1, wherein the predetermined special condition comprises a condition predetermined as indicating a risk of damage to the vehicle unless a configuration setting is changed.

10. The method of claim 1, as incorporating at least one IoT (Internet of Things) device comprising a device that can access a network via a communication channel.

11. The method of claim 10, wherein the IoT device comprises a cellular-based or satellite-based transceiver.

12. The method of claim 10, as implemented at least partially using a cloud service.

13. The method of claim 10, wherein the IoT device is used to acquire information related to determining that the special condition currently exists.

14. The method of claim 10, wherein the IoT device is used to communicate that the special condition is defined to currently exist.

15. A vehicle configuration override system circuit, comprising:
an input port to receive input data from one or more sensors on the vehicle;
a computation circuit for determining, using the sensor input data, that a predetermined special condition currently exists for which it is predetermined that a change in a configuration setting is desired;
a signal generation circuit for providing a signal to change the configuration setting from an original setting value to a new configuration setting value; and
an output port to provide the signal to change the configuration setting.

16. The vehicle configuration override system circuit of claim 15, wherein the computation circuit comprises a processor in a computer mounted in the vehicle.

17. The vehicle configuration override system circuit of claim 15, wherein the configuration setting is returned to the original setting value in response to determining that the predetermined special condition no longer exists.

18. The vehicle configuration override system circuit of claim 15, as incorporating at least on IoT (Internet of Things) device, each IoT device comprising a device that can access a network via a communication channel.

19. The vehicle configuration override system circuit of claim 18, wherein the IoT device comprises a device used to acquire information related to determining that the special condition currently exists.

20. A vehicle configuration setting override computer, comprising:
an input/output port for receiving input data from a vehicle communication bus and to provide a signal onto the vehicle communication bus;
a transceiver capable of accessing a network;
a processor; and
a memory device accessible to the processor for storing a set of instructions enabling the processor to implement a vehicle configuration setting override method comprising:
receiving input data from one or more sensors on the vehicle via the vehicle communication bus;
determining, using the sensor input data, that a predetermined special condition currently exists for which it is predetermined that a change in a configuration setting is desired because of potential damage to the vehicle if a configuration setting were not changed;
providing a signal to the vehicle communication bus to change the configuration setting from an original setting value to a new configuration setting value;
continuing to receive input data from the one or more sensors via the vehicle communication bus to monitor whether the predetermined condition continues to exist;
determining that the predetermined condition no longer exists; and
providing a signal to the vehicle communication bus to change the configuration setting value back to the original setting value,
wherein the determining that the predetermined special condition exists is based at least partially on information received from the network via the transceiver.
